(19) United States
(12) Patent Application Publication
(10) Pub. No.: US 2026/0005536 A1
(43) Pub. Date: Jan. 1, 2026

(54) CHARGING SYSTEM

(71) Applicant: Renesas Electronics America Inc., Milpitas, CA (US)

(72) Inventors: Nattorn PONGRATANANUKUL, San Jose, CA (US); Michael Marshall RENAULT, Medway, MA (US); Xiaopeng WANG, Mountain View, CA (US); Ying WU, Arcadiastraße (DE)

(73) Assignee: Renesas Electronics America Inc., Milpitas, CA (US)

(21) Appl. No.: 18/756,519

(22) Filed: Jun. 27, 2024

(51) Int. Cl. H02J 7/00

(52) U.S. Cl. CPC H02J 7/00712; H02J 7/0047; H02J 2207/50

(57) ABSTRACT

A charging system for sequentially charging an energy storage element over a plurality of operational phases is provided. The charging system includes a charging circuit and a control circuit. The charging circuit is configured to charge the energy storage element during a first operational phase. The control circuit configured to evaluate a first condition during the first operational phase. The control circuit is further configured to, based on the evaluation of the first condition, control the charging circuit to progress to the second operational phase or pause the charging of the energy storage element. The charging circuit is configured to charge the energy storage element during the second operational phase upon being controlled to progress to the second operational phase by the control circuit.

The present disclosure relates to a charging system for an energy storage element.

### BACKGROUND

In solid-state drive application, saving critical data from volatile memory (for example, DRAM) to non-volatile memory (for example, NAND) is a crucial requirement to avoid data loss during fault conditions such as an input power loss. The process of saving critical data from volatile to non-volatile memory during fault conditions is referred to as “power loss protection (PLP)” in the industry.

To realize such a feature an energy storage element, such as a capacitor, is charged to store energy as part of system initialization, and the stored energy is used as temporary energy source to allow sufficient time for the system to save critical data when the main input power is lost.

The integrity of the energy storage element, such as a storage capacitor, is an important factor to ensure the robustness of the back-up energy source. For example, due to aging storage capacitors may develop leakage anomalies relating to the leakage of current, which can hinder their suitability in functioning as a backup power source during a fault condition. Energy storage elements may, for example, have leakage properties that are sensitive to an increasing voltage level or above-voltage-rating operation, such as polarized capacitors with a voltage-limit rating. Measurement of leakage properties can also be used to detect reversed capacitor insertion.

### SUMMARY

It is desirable to provide a charging system for charging an energy storage element that improves on known systems.

Furthermore, it is desirable to provide a charging system for an energy storage element that can provide an improved power loss protection system, for example, for solid state drive applications.

According to a first aspect of the disclosure there is provided a charging system for sequentially charging an energy storage element over a plurality of operational phases, the charging system comprising a charging circuit configured to charge the energy storage element during a first operational phase, and a control circuit configured to evaluate a first condition during the first operational phase, and based on the evaluation of the first condition control the charging circuit to progress to the second operational phase, or pause the charging of the energy storage element; wherein the charging circuit is configured to charge the energy storage element during the second operational phase upon being controlled to progress to the second operational phase by the control circuit.

Optionally, the energy storage element comprises a capacitor.

Optionally, the control circuit is configured to evaluate the first condition during the first operational phase by evaluating whether the energy storage element will reach a target voltage before the end of the first operational phase, control the charging circuit to progress to the second operational phase if the energy storage element will reach the target voltage before the end of the first operational phase, and control the charging circuit to pause the charging of the energy storage element if the energy storage element will not reach the target voltage before the end of the first operational phase.

Optionally, the control circuit is configured to evaluate whether the energy storage element will reach the target voltage before the end of the first operational phase based on a charging rate of the energy storage element during the first phase.

Optionally, the control system comprises a logic circuit.

Optionally, the first operational phase comprises a first charging phase and a first testing phase, the second operational phase comprises a second charging phase, the charging circuit is configured to charge the energy storage element during the first charging phase and the second charging phase, and the control circuit is configured to evaluate the first condition during the first testing phase.

Optionally, the charging circuit is configured to charge the energy storage element to a first voltage during the first charging phase, and charge the energy storage element to a second voltage during the second charging phase, wherein the second voltage is greater than the first voltage.

Optionally, the control circuit comprises a comparison circuit, the comparison circuit is configured to compare the first leakage parameter to a first threshold parameter during the first operational phase, thereby evaluating the first condition during the first operational phase, and the control circuit is configured to progress to the second operational phase or pause the charging of the energy storage element based on the outcome of the comparison of the first leakage parameter and the first threshold parameter.

Optionally, the control circuit comprises a determination circuit configured to determine the first leakage parameter during the first operational phase.

Optionally, the comparison circuit comprises a comparator.

Optionally, the energy storage element comprises a capacitor.

Optionally, the first leakage parameter is approximately equal to the capacitance of the capacitor multiplied by a change in voltage of the capacitor divided by a current from the capacitor.

Optionally, the control circuit is configured to control the charging circuit to progress to the second operational phase if the first leakage parameter is less than the first threshold parameter, and control the charging circuit to pause the charging of the energy storage element if the first leakage parameter is greater than the first threshold parameter.

Optionally, the first leakage parameter is a first test voltage of the capacitor.

Optionally, the control circuit is configured to measure the first test voltage of the capacitor after a first time step has elapsed after the start of the first testing phase.

Optionally, the control circuit comprises an analog to digital converter configured to measure the first test voltage of the capacitor.

Optionally, the charging circuit is configured to charge the energy storage element to a first voltage during the first charging phase, and charge the energy storage element to a second voltage during the second charging phase upon being controlled to progress to the second operational phase by the control circuit, wherein the second voltage is greater than the first voltage.

Optionally, the first threshold parameter is approximately equal to the first target voltage multiplied by an exponential of negative the first time step divided by a capacitance of the capacitor multiplied by a leakage resistance.

Optionally, the control circuit is configured to evaluate a second condition during the second operational phase, and based on the evaluation of the second condition control the charging circuit to progress to a third operational phase, or pause the charging of the energy storage element, and the charging circuit is configured to charge the energy storage element during the third operational phase upon being controlled to progress to the third operational phase by the control circuit.

Optionally, the first operational phase comprises a first charging phase and a first testing phase, the second operational phase comprises a second charging phase and a second testing phase, the third operational phase comprises a third charging phase, the charging circuit is configured to charge the energy storage element during the first charging phase, the second charging phase upon being controlled to progress to the second operational phase by the control circuit and the third charging phase upon being controlled to progress the third operational phase by the control circuit, and the control circuit is configured to evaluate the first condition during the first testing phase, and evaluate the second condition during the second testing phase.

Optionally, the control circuit comprises a comparison circuit, the comparison circuit is configured to compare the first leakage parameter to a first threshold parameter during the first operational phase, thereby evaluating the first condition during the first operational phase, and compare the second leakage parameter to a second threshold parameter during the second operational phase, thereby evaluating the second condition during the second operational phase, and the control circuit is configured to control the charging circuit to progress to the second operational phase or pause the charging of the energy storage element based on the outcome of the comparison of the first leakage parameter and the first threshold parameter, and control the charging circuit to progress to the third operational phase or pause the charging of the energy storage element based on the outcome of the comparison of the second leakage parameter and the second threshold parameter.

Optionally, the control circuit comprises a determination circuit configured to determine the first leakage parameter during the first operational phase and the second leakage parameter during the second operational phase.

Optionally, the energy storage element comprises a capacitor.

Optionally, the first leakage parameter is a first test voltage of the capacitor and the second leakage parameter is a second test voltage of the capacitor.

Optionally, the control circuit is configured to measure the first test voltage of the capacitor after a first time step has elapsed after the start of the first testing phase, and measure the second test voltage of the capacitor after a second time step has elapsed after the start of the second testing phase.

Optionally, the control circuit comprises an analog to digital converter configured to measure the first and second test voltages of the capacitor.

Optionally, the charging circuit is configured to charge the energy storage element to a first voltage during the first charging phase, charge the energy storage element to a second voltage during the second charging phase, charge the energy storage element to a third voltage during the third charging phase, wherein the third voltage is greater than the second voltage and the second voltage is greater than the first voltage.

Optionally, the first threshold parameter is approximately equal to the first target voltage multiplied by an exponential of negative the first time step divided by a capacitance of the capacitor multiplied by a leakage resistance, and the second threshold parameter is approximately equal to the second target voltage multiplied by an exponential of negative the second time step divided by the capacitance of the capacitor multiplied by the leakage resistance.

Optionally, the first and second time steps are approximately equal.

Optionally, the charging system is configured to charge the energy storage element to a charged voltage.

Optionally, the control circuit is configured to evaluate whether the energy storage element will be charged to the charged voltage within a total charging time period, and control the charging circuit to halt the charging of the energy storage element if the energy storage element will not be charged to the charged voltage within the total charging time period.

Optionally, the control circuit is configured to evaluate whether the energy storage element has been charged to the charged voltage, and control the charging circuit to halt the charging of the energy storage element if the energy storage has been charged to the charged voltage.

Optionally, the first operational phase comprises a first charging phase, the second operational phase comprises a second charging phase, the charging circuit is configured to charge the energy storage element to a first voltage during the first charging phase, and charge the energy storage element to a second voltage during the second charging phase upon being controlled to progress to the second operational phase by the control circuit, and the second voltage is greater than the first voltage.

Optionally, the charging circuit is configured to charge the energy storage element to the first voltage during the first charging phase by applying the first voltage to the energy storage element, and charge the energy storage element to the second voltage during the second charging phase by applying the second voltage to the energy storage element.

Optionally, the charging circuit is configured to charge the energy storage element to the first voltage during the first charging phase by applying a first charging voltage to the energy storage element for a first charging duration, and charge the energy storage element to the second voltage during the second charging phase by applying a second charging voltage to the energy storage element for a second charging duration.

Optionally, the first charging voltage and the second charging voltage are approximately equal and/or the first charging duration and the second charging duration are approximately equal.

Optionally, the charging circuit comprises a power converter.

Optionally, the power converter comprises a switching converter.

Optionally, the switching converter is a boost converter.

According to a second aspect of the disclosure there is provided an electronic system comprising a power loss protection system for the electronic system, the power loss protection system comprising a charging system for sequentially charging an energy storage element over a plurality of operational phases during initialization of the electronic system, the charging system comprising a charging circuit configured to charge the energy storage element during a first operational phase, and a control circuit configured to evaluate a first condition during the first operational phase, and based on the evaluation of the first condition control the charging circuit to progress to the second operational phase, or pause the charging of the energy storage element, wherein the charging circuit is configured to charge the energy storage element during the second operational phase upon being controlled to progress to the second operational phase by the control circuit.

Optionally, the electronic system is a solid state drive.

Optionally, the apparatus comprises an integrated circuit comprising the power loss protection system and/or the electronic system.

It will be appreciated that the apparatus of the second aspect may include features of the first aspect, and can include other features as described herein in accordance with the understanding of the skilled person.

According to a third aspect of the disclosure there is provided a method of sequentially charging an energy storage element over a plurality of operational phases using a charging system, the method comprising charging the energy storage element during a first operational phase using a charging circuit, evaluating, using a control circuit a first condition during the first operational phase, and based on the evaluation of the first condition controlling the charging circuit using the control circuit to progress to the second operational phase, or pause the charging of the energy storage element, and charging the energy storage element during the second operational phase using the charging circuit, upon being controlled by the control circuit to progress to the second operational phase.

It will be appreciated that the method of the third aspect may include providing and/or using features set out in relation to the first and/or second aspects and may include other features as described herein, in accordance with the understanding of the skilled person.

### BRIEF DESCRIPTION OF THE DRAWINGS

The disclosure is described in further detail below by way of example and with reference to the accompanying drawings in which:

FIG. 1A is a schematic of a charging system for sequentially charging an energy storage element over a plurality of operational phases in accordance with a first embodiment of the present disclosure;

FIG. 1B is a schematic of a further embodiment of the charging system and the energy storage;

FIG. 1C is a timing graph showing an example operation of the charging system of FIG. 1B;

FIG. 1D is the timing graph of FIG. 1C shown over a shorter time period;

FIG. 2 is a schematic of a specific embodiment of the charging system, in accordance with a second embodiment of the present disclosure;

FIG. 3 is a schematic of a specific embodiment of the charging system, in accordance with a third embodiment of the present disclosure;

FIG. 4 is a schematic of a specific embodiment of the charging system, in accordance with a fourth embodiment of the present disclosure;

FIG. 5A is a timing graph showing experimental test results for a practical implementation of the circuit shown in FIG. 4;

FIG. 5B is a timing graph showing experimental test results for a further practical implementation of the circuit shown in FIG. 4;

FIG. 5C is a timing graph showing experimental test results for a further practical implementation of the circuit shown in FIG. 4;

FIG. 6A is a schematic of a specific embodiment of the charging system, in accordance with a fifth embodiment of the present disclosure;

FIG. 6B is a schematic of an alternative implementation for the comparison circuit and analog to digital converter as illustrated in FIG. 6A;

FIG. 6C is a timing graph showing an example operation of the charging system of FIG. 6A;

FIG. 7A is a timing graph showing experimental test results for a practical implementation of the circuit shown in FIG. 6A;

FIG. 7B is a timing graph showing experimental test results for a further practical implementation of the circuit shown in FIG. 6A; and

FIG. 8 is a schematic of an electronic system comprising an integrated circuit comprising a power loss protection system, in accordance with a sixth embodiment of the present disclosure.

### DETAILED DESCRIPTION

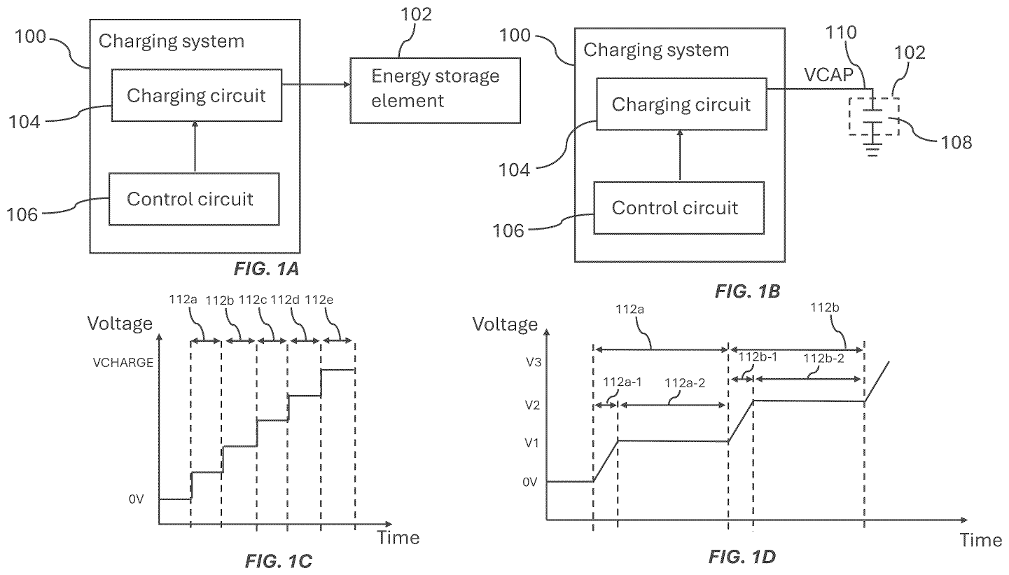

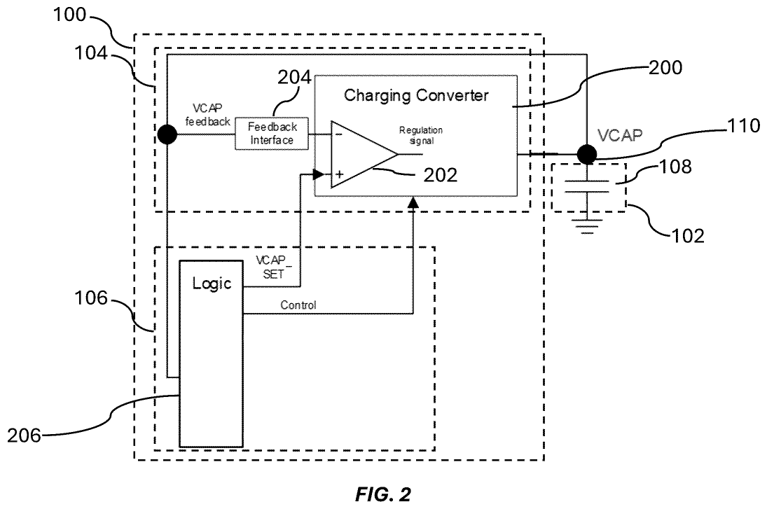

FIG. 1A is a schematic of a charging system 100 for sequentially charging an energy storage element 102 over a plurality of operational phases in accordance with a first embodiment of the present disclosure. The charging system 100 comprises a charging circuit 104 and a control circuit 106.

The sequential charging can enable the energy storage element 102 to be charged incrementally, for example, by having the charging circuit 104 apply successively increasing charging voltages until the energy storage element 102 is fully charged, or otherwise reaches a target charge level.

Incrementing the charging process means that the voltage stored by the energy storage element 102 can slowly increase thereby resulting in reduced voltage stress when compared with systems that do not use incremental charging.

FIG. 1B is a schematic of a further embodiment of the charging system 100 and the energy storage 102, where the energy storage element 102 comprises a capacitor 108. A charging voltage VCAP is applied by the charging circuit 104 and its value may be incrementally increased with each charging phase.

FIG. 1C is a timing graph showing an example operation of the charging system 100 of FIG. 1B showing a terminal voltage at a terminal 110 of the capacitor 108 as it is charged by the charging system 100.

The terminal voltage may simply be referred to as the voltage of the capacitor 108, or the voltage across the capacitor 108, as the voltage of the ground terminal is considered to be OV, in accordance with the understanding of the skilled person.

There is shown a plurality of operational phases 112a, 112b, 112c, 112d, 112e, with the capacitor 108 being sequentially charged from OV to VCHARGE. VCHARGE may denote a fully charged target voltage for the capacitor 108 to be charged to by the end of the charging process.

FIG. 1D is the timing graph of FIG. 1C shown over a shorter time period to show the terminal voltage increase from OV to a first voltage V1 during the first operational phase 112a, then increase from the first voltage V1 to a second voltage V2 during the second operational phase 112b, then increase from the second voltage V2 to a third voltage V3 during the third operational phase 112c.

It will be appreciated that specific embodiments of the present disclosure may include charging over two or more operational phases, in accordance with the understanding of the skilled person.

The plurality of operational phases comprises the first operational phase 112a and the second operational phase 112. The charging circuit 104 is configured to charge the energy storage element 102 during the first operational phase 112a.

The control circuit 106 is configured to evaluate a first condition during the first operational phase 112a. Based on the evaluation of the first condition the control circuit 106 may then control the charging circuit 104 to progress to the second operational phase 112b of charging the energy storage element 102, or pause the charging process.

The charging circuit 104 is configured to charge the energy storage element 102 during the second operational phase 112b upon being controlled to progress to the second operational phase 112b by the control circuit 106.

To simplify the explanation, the operation of the charging system 100 has been described in relation to charging during the operational phase 112a followed by charging during the operational phase 112b. It will be appreciated that, in further embodiments, the functionality as described in relation to the charging system 100 may be applied to any pair of operational phases. Furthermore, in further embodiments, the functionality as described in relation to the charging system 100 may be applied for two or more operational phases, and may be applied for all phases during the charging of the energy storage element 102.

In a specific embodiment, first condition as evaluated by the control circuit 106 may relate to whether the energy storage element 102 will reach a target voltage before the end of the first operational phase 112a, with the control circuit 106 controlling the charging circuit 104 to proceed to the second operational phase 112b if the target voltage will be reached before the end of the first operational phase 112a. Otherwise the control circuit 106 may control the charging circuit 104 to pause the charging procedure. The evaluation may be based on the charging rate.

In a specific embodiment, the control circuit 106 may implement timeout functionality where the charging procedure is halted if it is assessed that the energy storage element 102 will not reach a fully charged target voltage (for example “VCHARGE” as previously discussed) by the end of the total charging period.

Each of the operational phases may comprise a charging phase, with the energy storage element 102 being charged by the charging circuit 104 during the charging phase, and a testing phase, with the control circuit 106 evaluating a condition during the testing phase. In a specific embodiment, the first operational phase 112a comprises a charging phase 112a-1 and a testing phase 112a-2; and the second operational phase 112b comprises a charging phase 112b-1 and a testing phase 112b-2.

As discussed previously, the charging circuit 104 may apply successively increasing charging voltages until the energy storage element 102 is fully charged, or otherwise reaches a target charge level.

For example, the charging circuit 104 may charge the energy storage element 102 to the first voltage V1 during the first charging phase 112a-1 by applying a first charging voltage VA1 to the energy storage element 102 for a first charging duration TC1 and charge the energy storage element 102 to the second voltage V2 during the second charging phase 112b-1 by applying a second charging voltage VA2 to the energy storage 108 element for a second charging duration TC2. The charging duration TC1 may be the length of time of the charging phase 112a-1 and the charging duration TC2 may be the length of time of the charging phase 112b-1. The charging durations at each charging phase may be approximately equal. In the present example, the charging voltage VA2 is greater than the charging voltage VA1, with each subsequent charging voltage being greater than the last until the charging procedure is complete.

In a further embodiment, the charging voltages at each charging phase may be approximately equal. The charging voltage may, for example, be the fully charged target voltage with the voltage of the energy storage element 102 being controlled by the time that the voltage is applied. For example, during the first charging phase 112a-1 the charging voltage VA1 may be applied for the charging duration TC1 until the first voltage V1 is reached. In the next charging phase 112b-1, the charging voltage VA1 may be applied for the charging duration until the second voltage V2 is reached. The procedure may then be repeated until the voltage of the energy storage element 102 is approximately equal to the charging voltage VA1.

FIG. 2 is a schematic of a specific embodiment of the charging system 100, in accordance with a second embodiment of the present disclosure. In the present embodiment, the charging circuit 104 comprises a power converter 200. The power converter 200 may, for example, be a switching converter such as a boost converter. During operation, the control circuit 106 controls the power converter 200 to provide incrementally increasing voltages VCAP with each successive operational phase, as long as the condition for pausing the charging procedure remains unmet.

The power converter 200 may comprise a differential amplifier 202 configured to receive a feedback voltage VCAP feedback and a reference voltage VCAP_SET, and to output a regulation signal for control of the power converter 200 in the generation of the voltage VCAP. The feedback voltage VCAP feedback may be received via a feedback interface 204.

In the present embodiment, the control circuit 106 comprises a logic circuit 206 for providing a control signal “Control” and the reference voltage VCAP_SET. The control signal “Control” may be used to control the power converter 200 to progress to the next charging phase or to pause the charging operation, based on the evaluation of the condition for a given operational phase.

For example, in a specific embodiment, and as described previously, the first condition as evaluated by the control circuit 106 may relate to whether the energy storage element 102 will reach a target voltage before the end of the first operational phase 112a, with the control circuit 106 controlling the charging circuit 104 to proceed to the second operational phase 112b if the target voltage will be reached before the end of the first operational phase 112a. Otherwise the control circuit 106 may control the charging circuit 104 to pause the charging procedure. The evaluation may be based on the charging rate.

It will be appreciated that in a further embodiment, each subsequent operational phase may be subject to the evaluation of a condition relating to whether the energy storage element 102 will reach a target voltage for the present phase before the end of the present phase, with the charging process being paused by the control circuit 106 if the target voltage condition will not be met.

In summary, the VCAP rail is only allowed to boost to the next step if the voltage VCAP applied on the present step can reach the present target. In a specific embodiment, the stepping of VCAP may terminate when VCAP_SET reaches a threshold voltage level or when the energy storage element 102 is sufficiently charged as may be indicated by a target VCAP internal DAC code being reached.

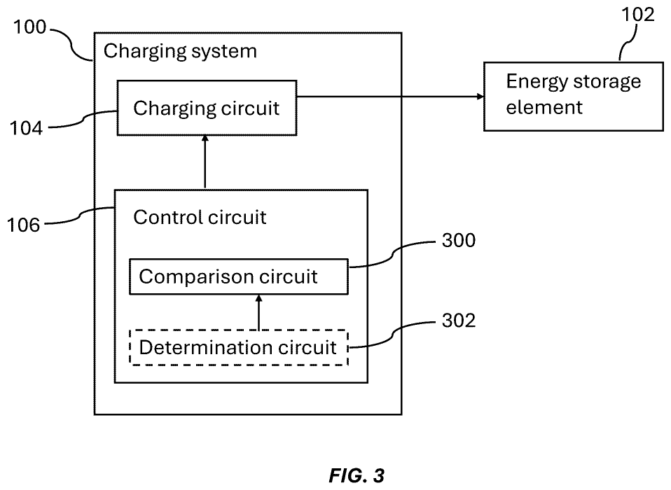

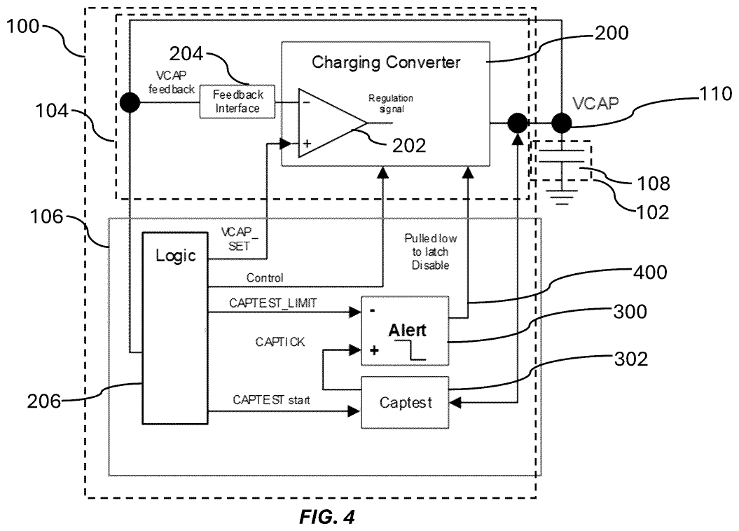

FIG. 3 is a schematic of a specific embodiment of the charging system 100, in accordance with a third embodiment of the present disclosure. In the present embodiment, the control circuit 106 comprises a comparison circuit 300 and may comprise a determination circuit 302. During the first operational phase, the determination circuit 302 determines a first leakage parameter, and the comparison circuit 300 compares the first leakage parameter to a first threshold parameter, thereby evaluating the first condition. The control circuit 106 then controls the charging circuit 104 to progress to the second operational phase 112b based on the outcome of the comparison.

The first leakage parameter may be indicative of a leakage property of the energy storage element 102 during the first operational phase. For example, the first leakage parameter may be estimate of the amount of charge leaked by the energy storage element 102 over a fixed time period, or may be a change on voltage of the energy storage element 102 over a fixed time period. The first leakage parameter may, for example, be measured directly, or indirectly, from the energy storage element 102. The first threshold parameter may be the desired value of the first leakage parameter, such that if the first leakage parameter is less than the first threshold parameter, the control circuit 106 controls the charging circuit 104 to pause the charging operation, as the minimum leakage requirements are not being met.

It will be appreciated that in further embodiments, the determination circuit 302 may determine leakage parameters for one or more subsequent operational phases, with, for each operational phase, the comparison circuit 300 comparing the leakage parameter to a threshold parameter, and determining whether to progress to the next operational phase, or pause the charging procedure, based on the comparison.

FIG. 4 is a schematic of a specific embodiment of the charging system 100, in accordance with a fourth embodiment of the present disclosure.

In the present embodiment, the comparison circuit 300 receives a signal CAPTICK and a signal CAPTEST_LIMIT and provides an output signal 400 to the power converter 200. The output signal 400 may be used to control the power converter 200 to pause the charging operation or to progress to the next operational phase.

The determination circuit 302 is coupled to an output terminal of the power converter 200 and receives a signal CAPTEST_start from the logic circuit 206.

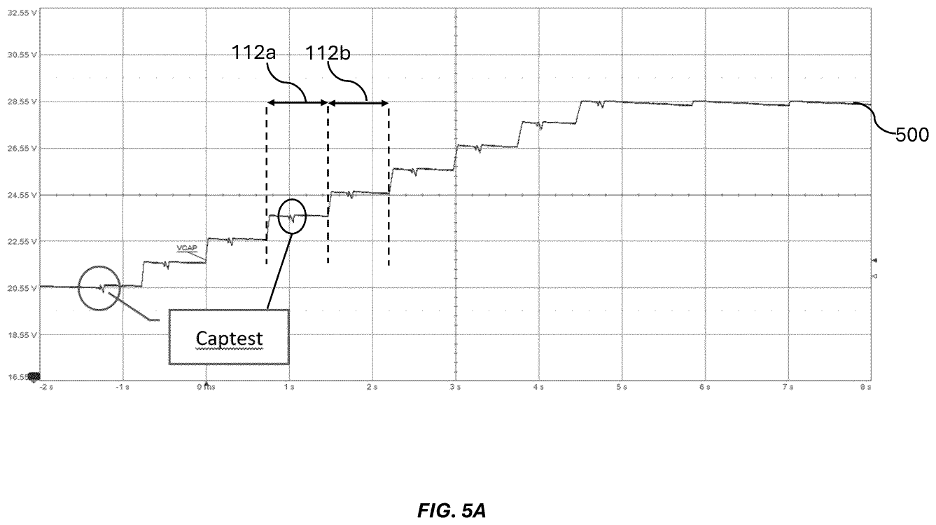

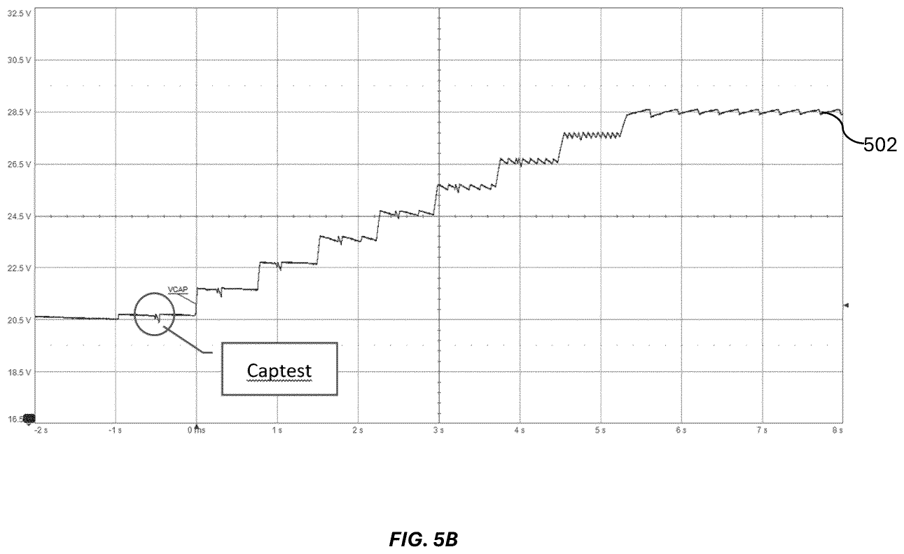

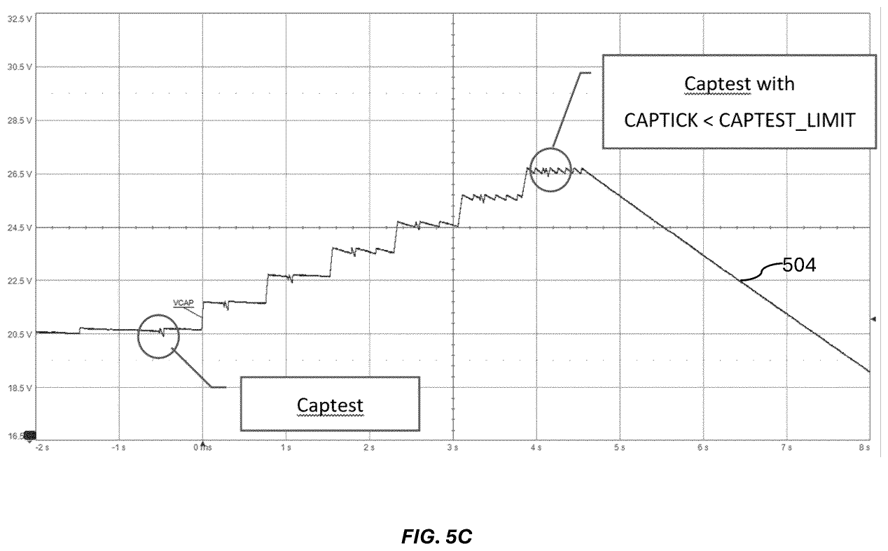

FIG. 5A is a timing graph showing experimental test results for a practical implementation of the circuit shown in FIG. 4. A trace 500 shows the terminal voltage of the capacitor 108, at the terminal 110, as it increases over the operational phases of the charging system 100. FIG. 5A shows a normal startup condition.

During each testing phase, the logic circuit 206 provides the signal CAPTEST_start to the determination circuit 302 which triggers the determination circuit 302 to determine the leakage parameter of the present operational phase. The leakage parameter, as determined is then provided to the comparison circuit 300 by the signal CAPTICK, which is then compared to the threshold parameter of the present phase, as provided by the signal CAPTEST_LIMIT.

The leakage parameter may be approximately equal to the capacitance C of the capacitor 108 multiplied by a change in voltage dV of the capacitor 108 divided by a current I from the capacitor 108, and may be represented by the following equation:

$$t = C \times \frac{dV}{I} \qquad ( 1 )$$

The first operational phase 112a and the second operational phase 112b have been labelled on FIG. 5A. It will be appreciated that the terms “first” and “second” in this context are used to distinguish between the two phases, and it is not essential that the “first” phase is the initial phase, and may in fact be preceded by other operational phases.

At the start of the first phase VCAP_SET steps up to increase the voltage VCAP as applied to charge the capacitor 108 during the charging phase of the operational phase 112a. During the testing phase of the operational phase 112a, the discharge test is run (which may be referred to as “captest”) to determine the leakage properties of the capacitor, and specifically to determine the first leakage parameter using equation (1).

The first leakage parameter is then provided by the signal CAPTICK to the comparison circuit 300, which compares the first leakage parameter to the first threshold parameter, as provided by the signal CAPTEST_LIMIT. If the first leakage parameter is less than the first threshold parameter (provided by CAPTICK<CAPTEST_LIMIT) the power converter 200 stops boosting (for example by no longer incrementing VCAP_SET or by otherwise disabling the power converter 200) and disables the VCAP rail to pause the charging process. The power converter 200 then waits to receive a VCAP boost re-enable signal before proceeding to the next operational phase.

If the first leakage parameter is greater than the first threshold parameter (provided by CAPTICK>CAPTEST_LIMIT), the logic circuit 206 continues to increment VCAP_SET to increase the charging voltage VCAP, and thereby progress to the second operational phase 112b. This procedure may then be repeated for subsequent phases, with the leakage properties of the capacitor 108 being determined during each operational phase, as is shown in FIG. 5A.

FIG. 5B is a timing graph showing experimental test results for a practical implementation of the circuit shown in FIG. 4. A trace 502 shows the terminal voltage of the capacitor 108, at the terminal 110, as it increases over the operational phases of the charging system 100. In the present example, the capacitor 108 exhibits higher leakage with higher voltages.

FIG. 5C is a timing graph showing experimental test results for a practical implementation of the circuit shown in FIG. 4. A trace 504 shows the terminal voltage of the capacitor 108, at the terminal 110, as it increases over the operational phases of the charging system 100. In the present example, the capacitor 108 exhibits higher leakage with higher voltages, and the condition of the leakage parameter being less than the threshold parameter being met during operation.

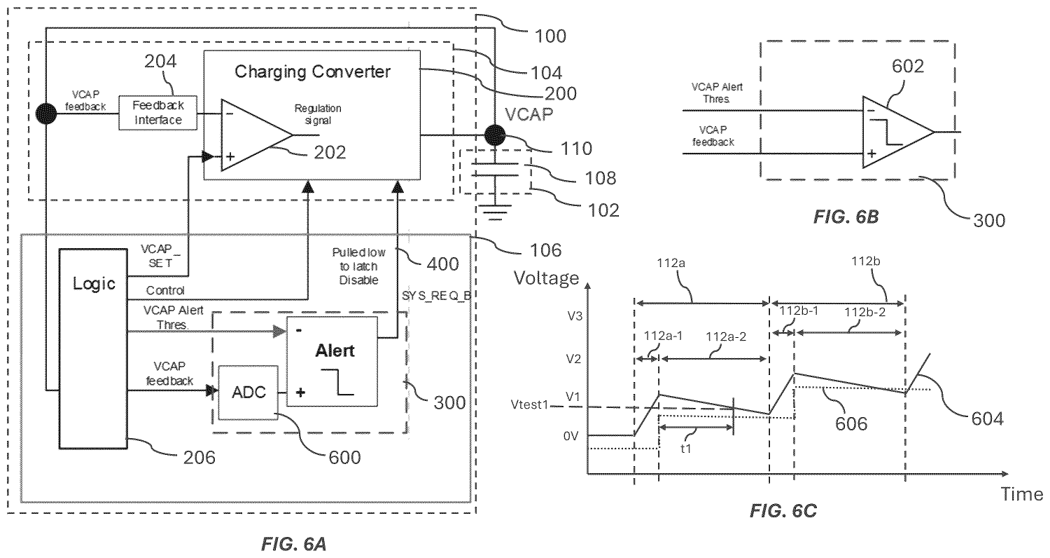

FIG. 6A is a schematic of a specific embodiment of the charging system 100, in accordance with a fifth embodiment of the present disclosure.

In the present embodiment, the comparison circuit 300 receives a signal VCAP feedback and a signal VCAP Alert Thres and provides an output signal 400 to the power converter 200. The output signal 400 may be used to control the power converter 200 to pause the charging operation or to progress to the next operational phase. The control circuit 106 comprises an analog to digital converter 600, with the signal VCAP feedback being converted from an analog signal to a digital signal prior to being provided to the comparison circuit 300. The signal VCAP Alert Thres may be a digital signal.

FIG. 6B is a schematic of an alternative implementation for the comparison circuit 300 and analog to digital converter 600 as illustrated in FIG. 6A, where the analog to digital converter 600 is omitted and the comparison circuit 300 comprises a comparator 602.

In the present embodiment, the leakage parameter is a test voltage of the capacitor 108. The control circuit 106 is configured to measure the test voltage of the capacitor 108 after a time step has elapsed after the start of the testing phase. The analog to digital converter 600 may measure the test voltage of the capacitor 108 at each operational phase.

FIG. 6C is a timing graph showing an example operation of the charging system 100 of FIG. 6A. There is shown the terminal voltage of the capacitor 108 (a trace 604) and the threshold parameter (a trace 606). The terminal voltage increases from OV to a first voltage V1 during the first operational phase 112a, then increase from the first voltage V1 to a second voltage V2 during the second operational phase 112b, then increase from the second voltage V2 to a third voltage V3 during the third operational phase 112c. In the present example, due to leakage properties of the capacitor 108, the terminal voltage decreases at the end of each charging phase. It can be observed that the threshold parameter steps up with each testing phase.

An example of the signal VCAP Alert Thres is provided by the trace 606 and an example of the signal VCAP feedback is provided by the trace 604.

With reference to the first operational phase 112a, the control circuit 106 may measure the test voltage VTest1 of the capacitor 108 after a time step t1 has elapsed after the start of the testing phase 112a-2. In the present example, the test voltage VTest1 as measured, is the terminal voltage of the capacitor 108 after the time step t1 has elapsed. The control circuit 106 then compares the test voltage VTest1 to the threshold parameter during the first testing phase 112a-2. This procedure may be referred to as a natural leakage test or natural discharge test.

During each testing phase, the threshold parameter may be calculated using the following equation:

$$VThreshold\_n = VTarget\_n \times {e}^{( \frac{- t n}{R C} )} \qquad ( 2 )$$

where VThreshold_n is the threshold voltage during the nth testing phase, VTarget_n is the nth target voltage, tn is the time step for the nth phase, R is the leakage resistance of the capacitor 108 and C is the capacitance of the capacitor. The time step tn may be the same for all operational phases.

The target voltage VTarget_n is the target voltage for the nth charging phase and will be approximately equal to the voltage of the energy storage element 102 for the nth phase, if the target voltage VTarget_n has been reached by the end of the charging phase.

Every time the target voltage is increased, the threshold voltage is increased, in accordance with equation (2). Equation (2) indicates the expected voltage for a given target voltage VTarget_n, decay time tn, capacitance C and permissible leakage resistance R.

For the first testing phase, the first threshold voltage VThreshold_1 us as follows:

$$VThreshold\_ 1 = VTarget\_ 1 \times {e}^{( \frac{- t 1}{R C} )} \qquad ( 3 )$$

During the first testing phase 112a-2, the control circuit 106 compares the first test voltage VTest1 to the first threshold voltage VThreshold_1. The first test voltage VTest1 is acquired after having waited for the known decay time t1.

If VTest1<VThreshold_1, the control circuit 106 controls the charging circuit 104 to pause the charging process. If VTest1>VThreshold_1 the control circuit 106 controls the charging circuit 104 to proceed on to the next operational phase, for example as shown in FIG. 6C. If paused, the process may be restarted subject to a re-enablement signal being received.

It will be appreciated that the above procedure may be repeated for subsequent operational phases and the description relating to the first operational phase is for illustrative purposes. For example, after the control circuit 106 controls the charging circuit 104 to proceed on to the second operational phase 112b, the procedure may be repeated for each subsequent operational phase until a fault condition is met, or the energy storage element 102 is fully charged.

In a specific embodiment, the analog to digital convertor 600 periodically samples the terminal voltage of the capacitor 108. The comparison circuit 300, functioning as a digital comparator, compares the sampled voltage and the threshold value, for example as provided by equation (2) and shown by the signal VCAP Alert Thres in FIG. 6A. Failure is declared when the voltage sampled by the analog to digital converter 600 is less than the threshold value, with an indicator signal SYSREQ_B being provided to the power converter 200 to halt the charging process. In the present example the indicator signal SYSREQ_B is the output signal 400 as previously discussed.

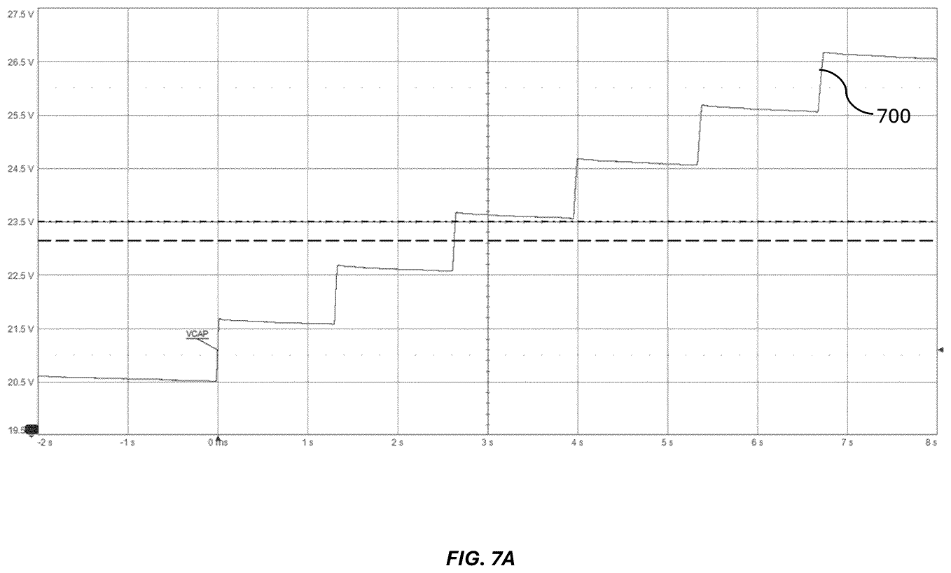

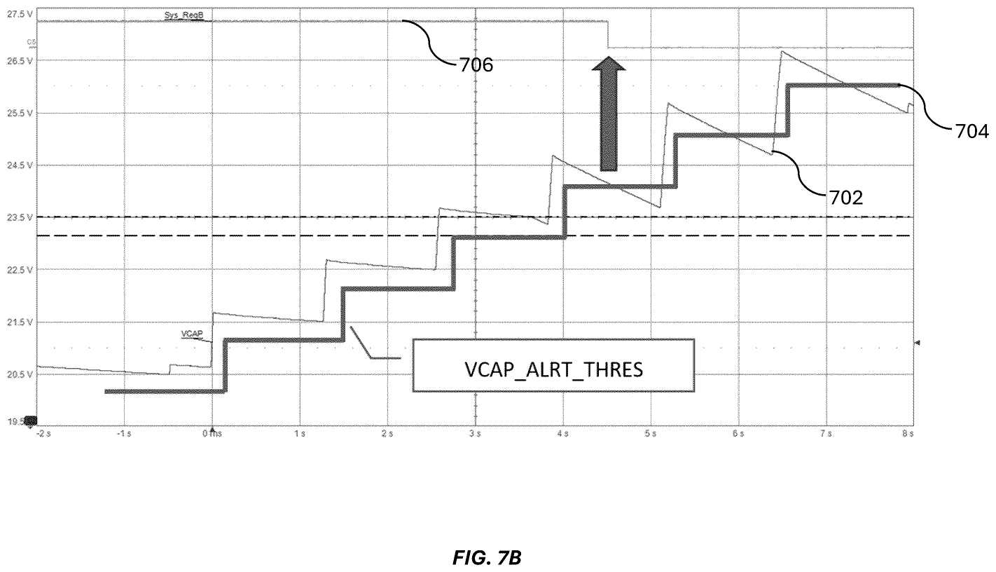

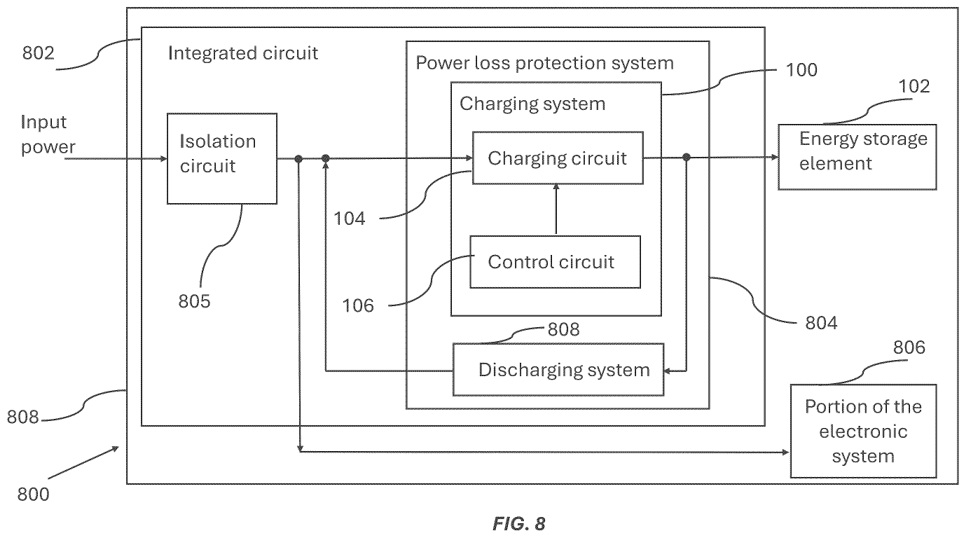

FIG. 7A is a timing graph showing experimental test results for a practical implementation of the circuit shown in FIG. 6A. A trace 700 shows the terminal voltage of the capacitor 108, at the terminal 110, as it increases over the operational phases of the charging system 100. The present example shows the application of a natural-discharge test with normal conditions.

FIG. 7B is a timing graph showing experimental test results for a further practical implementation of the circuit shown in FIG. 6A. A trace 702 shows the terminal voltage of the capacitor 108, at the terminal 110, as it increases over the operational phases of the charging system 100. A trace 704 shows the threshold voltage signal corresponding to VCAP Alert Thres. A trace 706 shows the indicator signal SYSREQ_B during operation. In the present example, the capacitor 108 exhibits higher leakage with higher voltages, and the condition of the leakage parameter being less than the threshold parameter is met during operation. It can be observed the indicator signal SYSREQ_B transitions from high to low when the fault condition is met.

FIG. 8 is a schematic of an electronic system 800 comprising an integrated circuit 802 comprising a power loss protection system 804, in accordance with a sixth embodiment of the present disclosure. The electronic system 800 may, for example, be a solid state drive and/or an industrial hold-up energy storage solution.

The power loss protection system 804 comprises the charging system 100 and energy storage element 102, which may be implemented using any of the embodiments described herein, in accordance with the understanding of the skilled person.

During initialisation of the electronic system 800, input power is received, for example via an isolation circuit 805, and provided to at least a portion 806 of the electronic system 800 for initialisation and to the charging system 100 that may charge the energy storage element 102 to function as a backup power source for the electronic system 800. Power may be provided from the energy storage element 102 to the portion 806 of the electronic system 800 via a discharging system 808.

In summary, embodiments of the present disclosure may be used to check a leakage current or perform a capacitor health check at intermediate voltage/time steps during charging process and avoid increasing to the next voltage step if an anomaly is found at the present voltage level. Furthermore, embodiments of the present disclosure may be used to detect leakage anomalies early in the charging process using built-in capabilities of the integrated circuit.

Known systems do not have the capability to check for leakage during the charging process and only check once at the end of the expected charged time which may be too long, and/or rely on external components to do so.

Therefore, embodiments of the present disclosure can provide an improved charging system for charging an energy storage element which can provide improved power loss protection systems, as may be applied in sold-state drive applications.

Common references numerals and variables between Figures represent common features. Various improvements and modifications may be made to the above without departing from the scope of the disclosure.

1. A charging system for sequentially charging an energy storage element over a plurality of operational phases, the charging system comprising:
a charging circuit configured to charge the energy storage element during a first operational phase; and
a control circuit configured to:
evaluate a first condition during the first operational phase; and
based on the evaluation of the first condition control the charging circuit to:
progress to the second operational phase, or
pause the charging of the energy storage element;
wherein the charging circuit is configured to charge the energy storage element during the second operational phase upon being controlled to progress to the second operational phase by the control circuit.

2. The charging system of claim 1, wherein:
the control circuit is configured to:
evaluate the first condition during the first operational phase by evaluating whether the energy storage element will reach a target voltage before the end of the first operational phase;
control the charging circuit to progress to the second operational phase if the energy storage element will reach the target voltage before the end of the first operational phase; and
control the charging circuit to pause the charging of the energy storage element if the energy storage element will not reach the target voltage before the end of the first operational phase.

3. The charging system of claim 2, wherein the control circuit is configured to evaluate whether the energy storage element will reach the target voltage before the end of the first operational phase based on a charging rate of the energy storage element during the first phase.

4. The charging system of claim 1, wherein:
the first operational phase comprises a first charging phase and a first testing phase;
the second operational phase comprises a second charging phase;
the charging circuit is configured to charge the energy storage element during the first charging phase and the second charging phase; and
the control circuit is configured to evaluate the first condition during the first testing phase.

5. The charging system of claim 4, wherein:
the control circuit comprises a comparison circuit;
the comparison circuit is configured to compare the first leakage parameter to a first threshold parameter during the first operational phase, thereby evaluating the first condition during the first operational phase; and
the control circuit is configured to progress to the second operational phase or pause the charging of the energy storage element based on the outcome of the comparison of the first leakage parameter and the first threshold parameter.

6. The charging system of claim 5, wherein:
the energy storage element comprises a capacitor and
the first leakage parameter is approximately equal to the capacitance of the capacitor multiplied by a change in voltage of the capacitor divided by a current from the capacitor.

7. The charging system of claim 6, wherein the control circuit is configured to:
control the charging circuit to progress to the second operational phase if the first leakage parameter is less than the first threshold parameter; and
control the charging circuit to pause the charging of the energy storage element if the first leakage parameter is greater than the first threshold parameter.

8. The charging system of claim 6, wherein the first leakage parameter is a first test voltage of the capacitor.

9. The charging system of claim 8, wherein the control circuit is configured to measure the first test voltage of the capacitor after a first time step has elapsed after the start of the first testing phase.

10. The charging system of claim 9, wherein the charging circuit is configured to:
charge the energy storage element to a first voltage during the first charging phase; and
charge the energy storage element to a second voltage during the second charging phase upon being controlled to progress to the second operational phase by the control circuit; wherein:
the second voltage is greater than the first voltage.

11. The charging system of claim 10, wherein the first threshold parameter is approximately equal to the first target voltage multiplied by an exponential of negative the first time step divided by a capacitance of the capacitor multiplied by a leakage resistance.

12. The charging system of claim 1, wherein:
the control circuit is configured to:
evaluate a second condition during the second operational phase; and
based on the evaluation of the second condition control the charging circuit to:
progress to a third operational phase; or
pause the charging of the energy storage element; and
the charging circuit is configured to charge the energy storage element during the third operational phase upon being controlled to progress to the third operational phase by the control circuit.

13. The charging system of claim 12, wherein:
the first operational phase comprises a first charging phase and a first testing phase;
the second operational phase comprises a second charging phase and a second testing phase;
the third operational phase comprises a third charging phase;
the charging circuit is configured to:
charge the energy storage element during the first charging phase, the second charging phase upon being controlled to progress to the second operational phase by the control circuit and the third charging phase upon being controlled to progress the third operational phase by the control circuit; and
the control circuit is configured to:
evaluate the first condition during the first testing phase; and
evaluate the second condition during the second testing phase.

14. The charging system of claim 13, wherein:
the control circuit comprises a comparison circuit;
the comparison circuit is configured to:
compare the first leakage parameter to a first threshold parameter during the first operational phase, thereby evaluating the first condition during the first operational phase; and
compare the second leakage parameter to a second threshold parameter during the second operational phase, thereby evaluating the second condition during the second operational phase; and
the control circuit is configured to:
control the charging circuit to progress to the second operational phase or pause the charging of the energy storage element based on the outcome of the comparison of the first leakage parameter and the first threshold parameter; and
control the charging circuit to progress to the third operational phase or pause the charging of the energy storage element based on the outcome of the comparison of the second leakage parameter and the second threshold parameter.

15. The charging system of claim 14, wherein:
the energy storage element comprises a capacitor;
the first leakage parameter is a first test voltage of the capacitor and the second leakage parameter is a second test voltage of the capacitor; and
the control circuit is configured to:
measure the first test voltage of the capacitor after a first time step has elapsed after the start of the first testing phase; and
measure the second test voltage of the capacitor after a second time step has elapsed after the start of the second testing phase.

16. The charging system of claim 15, wherein the charging circuit is configured to:
charge the energy storage element to a first voltage during the first charging phase;
charge the energy storage element to a second voltage during the second charging phase;
charge the energy storage element to a third voltage during the third charging phase; wherein:
the third voltage is greater than the second voltage and the second voltage is greater than the first voltage.

17. The charging system of claim 1, wherein
the first operational phase comprises a first charging phase;
the second operational phase comprises a second charging phase;
the charging circuit is configured to:
charge the energy storage element to a first voltage during the first charging phase; and
charge the energy storage element to a second voltage during the second charging phase upon being controlled to progress to the second operational phase by the control circuit; and
the second voltage is greater than the first voltage.

18. The charging system of claim 17, wherein the charging circuit is configured to:
charge the energy storage element to the first voltage during the first charging phase by applying the first voltage to the energy storage element and charge the energy storage element to the second voltage during the second charging phase by applying the second voltage to the energy storage element; or
charge the energy storage element to the first voltage during the first charging phase by applying a first charging voltage to the energy storage element for a first charging duration and charge the energy storage element to the second voltage during the second charging phase by applying a second charging voltage to the energy storage element for a second charging duration.

19. An electronic system comprising a power loss protection system for the electronic system, the power loss protection system comprising a charging system for sequentially charging an energy storage element over a plurality of operational phases during initialization of the electronic system, the charging system comprising:
a charging circuit configured to charge the energy storage element during a first operational phase; and
a control circuit configured to:
evaluate a first condition during the first operational phase; and
based on the evaluation of the first condition control the charging circuit to:
progress to the second operational phase; or
pause the charging of the energy storage element; wherein:
the charging circuit is configured to charge the energy storage element during the second operational phase upon being controlled to progress to the second operational phase by the control circuit.

20. A method of sequentially charging an energy storage element over a plurality of operational phases using a charging system, the method comprising:
charging the energy storage element during a first operational phase using a charging circuit;
evaluating, using a control circuit a first condition during the first operational phase; and
based on the evaluation of the first condition controlling the charging circuit using the control circuit to:
progress to the second operational phase; or
pause the charging of the energy storage element; and
charging the energy storage element during the second operational phase using the charging circuit, upon being controlled by the control circuit to progress to the second operational phase.
